(19) United States
(12) Patent Application Publication
(10) Pub. No.: US 2024/0218740 A1
(43) Pub. Date: Jul. 4, 2024

(54) BOX RAIL BACKUP AND METHOD

(71) Applicant: Werner Co., Greenville, PA (US)

(72) Inventors: Thomas W. Parker, Jamestown, PA (US); Kevin McIntire, Stoneboro, PA (US); Steve Dings, Mentor, OH (US); Robert D. Beggs, Stoneboro, PA (US); David Plotner, Sharpsville, PA (US)

(21) Appl. No.: 18/390,833

(22) Filed: Dec. 20, 2023

Related U.S. Application Data
(63) Continuation of application No. 16/795,086, filed on Feb. 19, 2020, now Pat. No. 11,885,181.
(60) Provisional application No. 62/954,276, filed on Dec. 27, 2019.
(60) Provisional application No. 62/954,290, filed on Dec. 27, 2019.

(51) Int. Cl. E06C 7/08; E06C 1/12; E06C 7/50

(52) U.S. Cl. CPC E06C 7/085; E06C 1/12; E06C 7/08; E06C 7/086; E06C 7/50

(57) ABSTRACT

A ladder having a first box rail having a first side, and a second side extending perpendicularly from the first side. The first side having a first hole. The second side having a first hole in alignment with the first hole of the first side. The ladder comprises a first hollow tube disposed in the first box rail in alignment with the first hole of the first side and the first hole of the third side. The ladder comprises a bracket having a first bracket hole in alignment with the first hole of the first side. The ladder comprises a first fastener extending through the first hole of the third side, the first hollow tube, the first hole of the first side and the first hole of the bracket which attaches the bracket to the first box rail.

### CROSS-REFERENCE TO RELATED APPLICATIONS

This application is a continuation of U.S. application Ser. No. 16/795,086, filed Feb. 19, 2020, which claims priority from U.S. provisional application Ser. No. 62/954,276, filed Dec. 27, 2019, and U.S. provisional application Ser. No. 62/954,290, filed Dec. 27, 2019, both of which are incorporated by reference herein. This application also incorporates by reference U.S. patent application Ser. No. 16/795,132 filed concurrently with this application on Feb. 19, 2020; and incorporates by reference U.S. patent application Ser. No. 16/795,171 filed concurrently with this application on Feb. 19, 2020.

### FIELD OF THE INVENTION

The present invention is related to components and a method of supporting or backing up the webs of hollow structural elements such as ladder box rails so that rivets or other fasteners which pass through the webs can be firmly clinched or tightened to hold components securely to the rails without causing the webs of the rail to flex inward. (As used herein, references to the “present invention” or “invention” relate to exemplary embodiments and not necessarily to every embodiment encompassed by the appended claims.)

### BACKGROUND OF THE INVENTION

This section is intended to introduce the reader to various aspects of the art that may be related to various aspects of the present invention. The following discussion is intended to provide information to facilitate a better understanding of the present invention. Accordingly, it should be understood that statements in the following discussion are to be read in this light, and not as admissions of prior art.

Box rails have great torsional rigidity compared to C or I cross section rails. This results in a ladder with box rails having greater torsional stiffness for the same weight. The difficulty lies in trying to secure components to the box rails such as guide brackets, locks, foot assemblies, etc., using inexpensive rivets. U.S. Pat. No. 7,086,499 describes collars positioned between the webs of a hollow rail which surround rungs specifically. This invention permits rivets to be solidly supported when clinched even though they pass through a hollow box rail.

### BRIEF SUMMARY OF THE INVENTION

The present invention pertains to a ladder. The ladder comprises a first box rail having a first side, a second side extending perpendicularly from the first side, a third side extending perpendicularly from the second side and in parallel and spaced relation with the first side, and a fourth side extending perpendicularly from the third side and in parallel and spaced relation with the second side. The first side having a first hole and preferably a second hole. The third side having a first hole in alignment with the first hole of the first side and preferably a second hole in alignment with the second hole of the first side. The ladder comprises a second box rail, at least a portion of which is in parallel and spaced relation with the first box rail. The ladder comprises a first rung attached to and extending between the first and second box rails. The ladder comprises a second rung attached to and extending between the first and second box rails. The ladder comprises a first hollow tube disposed in the first box rail in alignment with the first hole of the first side and the first hole of the second side. The ladder preferably comprises a second hollow tube disposed in the first box rail in alignment with the second hole of the first side and the second hole of the third side. The ladder comprises a bracket having a first bracket hole in alignment with the first hole of the first side and preferably a second bracket hole in alignment with the second hole of the first side. The ladder comprises a first fastener extending through the first hole of the third side, the first hollow tube, the first hole of the first side and the first hole of the bracket which attaches the bracket to the first box rail. The ladder preferably comprises a second fastener extending through the second hole of the third side, the second hollow tube, the second hole of the first side and the second bracket hole of the bracket which attaches the bracket to the first box rail.

The present invention pertains to a method for using a ladder. The method comprises the steps of moving the ladder to a desired location. There is the step of securing the ladder at the desired location so a user may safely climb the ladder. The ladder is described above.

The present invention pertains to a method for producing a ladder. The method comprises the steps of attaching a bracket to a first box rail of the ladder by inserting a first fastener through a first hole of a third side of the first box rail of the ladder, a first hollow tube, a first hole of a first side of the first box rail and a first hole of a bracket. The ladder having a second box rail, at least a portion of which is in parallel and spaced relation with the first box rail, a first rung attached to and extending between the first and second box rails, and a second rung attached to and extending between the first and second box rails. There is preferably the step of inserting a second fastener extending through a second hole of the third side, a second hollow tube, a second hole of the first side and a second bracket hole of the bracket so the first hollow tube is disposed in the first box rail in alignment with the first hole of the first side and the first hole of the second side. The second hollow tube is disposed in the first box rail in alignment with the second hole of the first side and the second hole of the second side, and the first bracket hole of the bracket is in alignment with the first hole of the first side and the second bracket hole is in alignment with the second hole of the first side.

### BRIEF DESCRIPTION OF THE SEVERAL VIEWS OF THE DRAWING

In the accompanying drawings, the preferred embodiment of the invention and preferred methods of practicing the invention are illustrated in which:

FIGS. 1A-1E show a short section of a hollow structural member.

FIGS. 2A and 2B show the assembly of a guide bracket to the box rail using solid rivets but without any kind of backup.

FIG. 2C shows the rivets clinched with clinches.

FIGS. 3A-3C provide views of the interaction of the unsupported rivets with the box rail.

FIGS. 4A-4E show how a box rail would be pierced to receive the backup supports of this invention.

FIGS. 5A-5D show the simplest embodiment of this invention.

FIGS. 6A-6C show the interaction of the rivets, webs, backups and bracket.

FIGS. 7A and 7E-7G show four backup tubes molded together in a bundle with a thin plate connecting them to each other.

FIG. 7B shows a bracket with a relief.

FIG. 7C shows how all four backup support tubes may be inserted into the box rail simultaneously.

FIG. 7D shows the assembly with rivets clinched.

FIGS. 7H-7M shows two backup tubes having catches molded together in a bundle with a thin plate connecting them to each other.

FIGS. 8A-8C show that the bracket is firmly clinched against the thin plate of the backup support tubes.

FIGS. 9A-9E show a further development of the embodiment of FIGS. 7A-7G. Catches are formed on one side of each of the four backup support tubes within the bundle.

FIGS. 10A and 10B show the assembling and final clinched condition of the bracket and box rail assembly.

FIGS. 11A-11C show how the catches on the backup tube bundle support the web adjacent to the bracket so that it will not flex inward.

FIGS. 12A-12C show a ladder with a guide bracket.

FIG. 13 shows a ladder with a lock bracket.

FIG. 14 shows a ladder of the claimed invention.

### DETAILED DESCRIPTION OF THE INVENTION

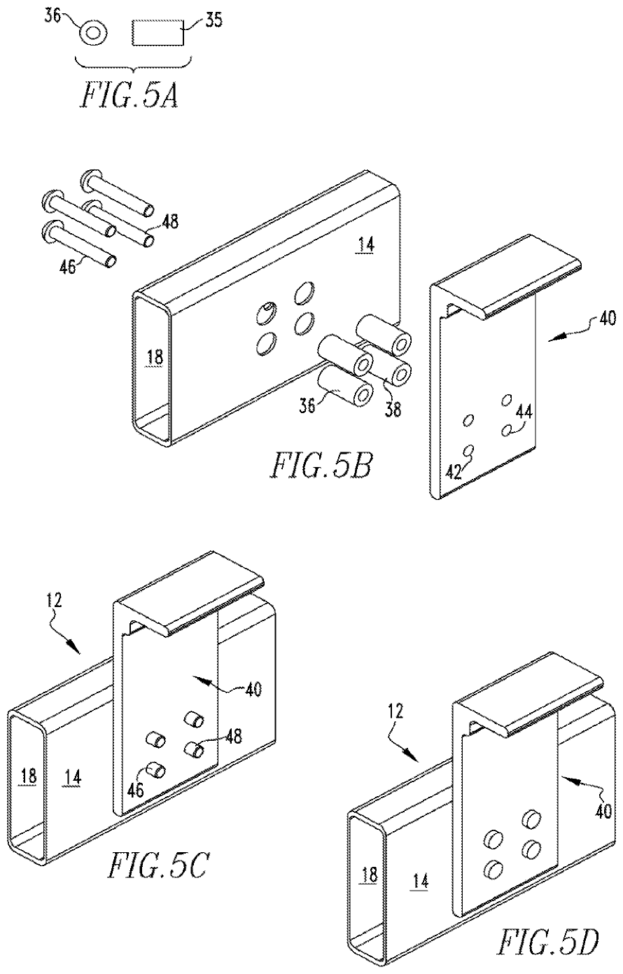

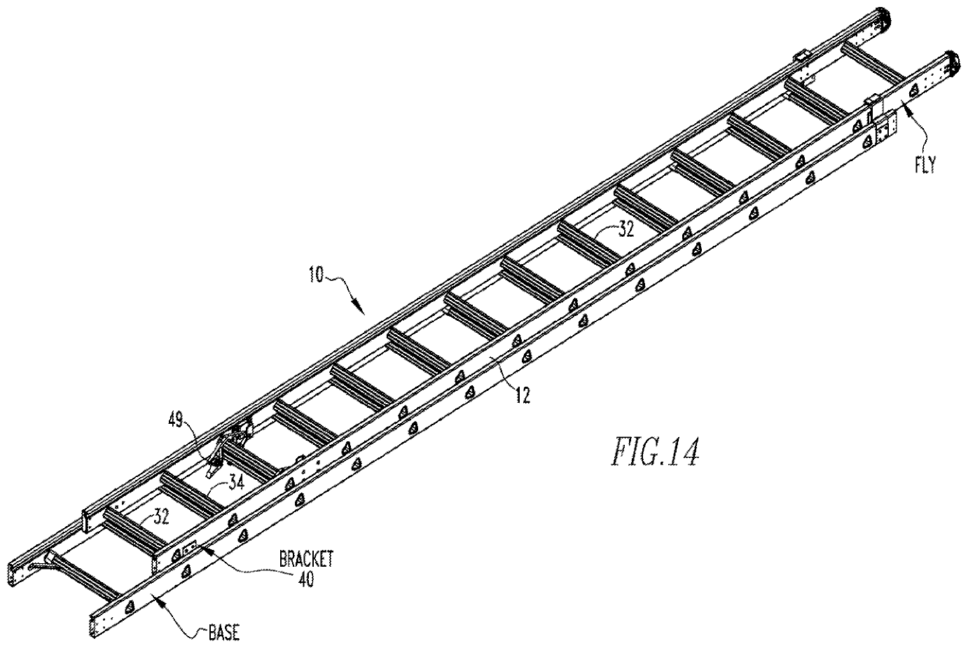

Referring now to the drawings wherein like reference numerals refer to similar or identical parts throughout the several views, and more specifically to FIGS. 5A-5D, 6A-6C, 12A and 14 thereof, there is shown a ladder 10. The ladder 10 comprises a first box rail 12 having a first side 14, a second side 16 extending perpendicularly from the first side 14, a third side 18 extending perpendicularly from the second side 16 and in parallel and spaced relation with the first side 14, and a fourth side 20 extending perpendicularly from the third side 18 and in parallel and spaced relation with the second side 16. The first side 14 having a first hole 22 and preferably a second hole 24. The third side 18 having a first hole 26 in alignment with the first hole 22 of the first side 14 and preferably a second hole 26 in alignment with the second hole 24 of the first side 14. The ladder 10 comprises a second box rail 30, at least a portion of which is in parallel and spaced relation with the first box rail 12. The ladder 10 comprises a first rung 32 attached to and extending between the first and second box rails 12, 30. The ladder 10 comprises a second rung 34 attached to and extending between the first and second box rails 12, 30. The ladder 10 comprises a first hollow tube 36 disposed in the first box rail 12 in alignment with the first hole 22 of the first side 14 and the first hole 26 of the third side 18. The ladder 10 preferably comprises a second hollow tube 38 disposed in the first box rail 12 in alignment with the second hole 24 of the first side 14 and the second hole 28 of the third side 18. The ladder 10 comprises a bracket 40 having a first bracket hole 42 in alignment with the first hole 22 of the first side 14 and preferably a second bracket hole 44 in alignment with the second hole 24 of the first side 14. The ladder 10 comprises a first fastener 46 extending through the first hole 26 of the third side 18, the first hollow tube 36, the first hole 22 of the first side 14 and the first hole 42 of the bracket which attaches the bracket 40 to the first box rail 12. The ladder 10 preferably comprises a second fastener 48 extending through the second hole 28 of the third side 18, the second hollow tube 38, the second hole 24 of the first side 14 and the second bracket hole 44 of the bracket 40 which attaches the bracket 40 to the first box rail 12. The number of holes and tubes in the first and third sides may simply be one or two or three or four or even more, depending on what is desired and needed to insure a stable and sturdy attachment with one or two or three or four or even more fasteners positioned in the respective holes and respective tubes to hold a desired object.

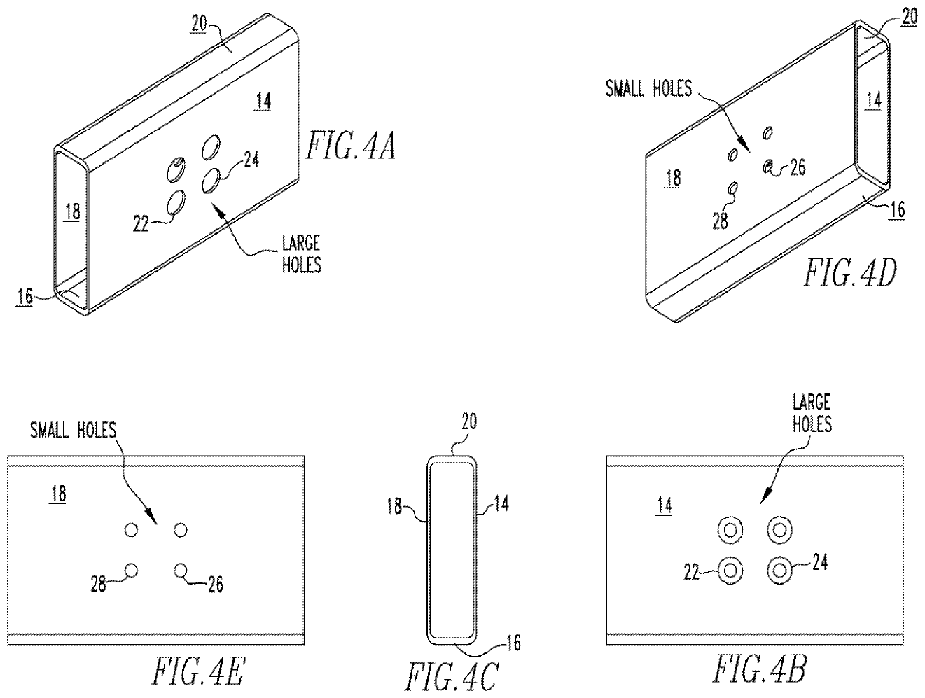

The first and second holes 22, 24 of the first side 14 may have a larger diameter than the first and second holes 26, 28 of the third side 18, as shown in FIGS. 4A-4E. The diameter of the first and second tubes 36, 38 may be larger than the diameter of the first and second holes 26, 28 of the third side 18. An outside end 50 of the first tube 36 may be disposed in the first hole 22 of the first side 14 and an outside end 52 of the second tube 38 may be disposed in the second hole 24 of the first side 14, as shown in FIGS. 5A-5D.

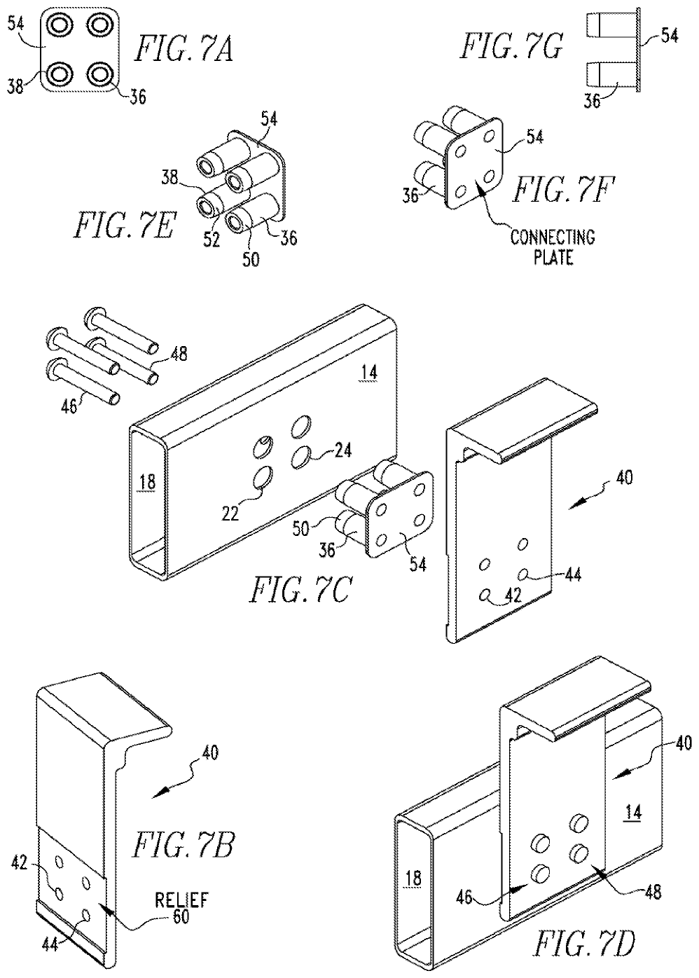

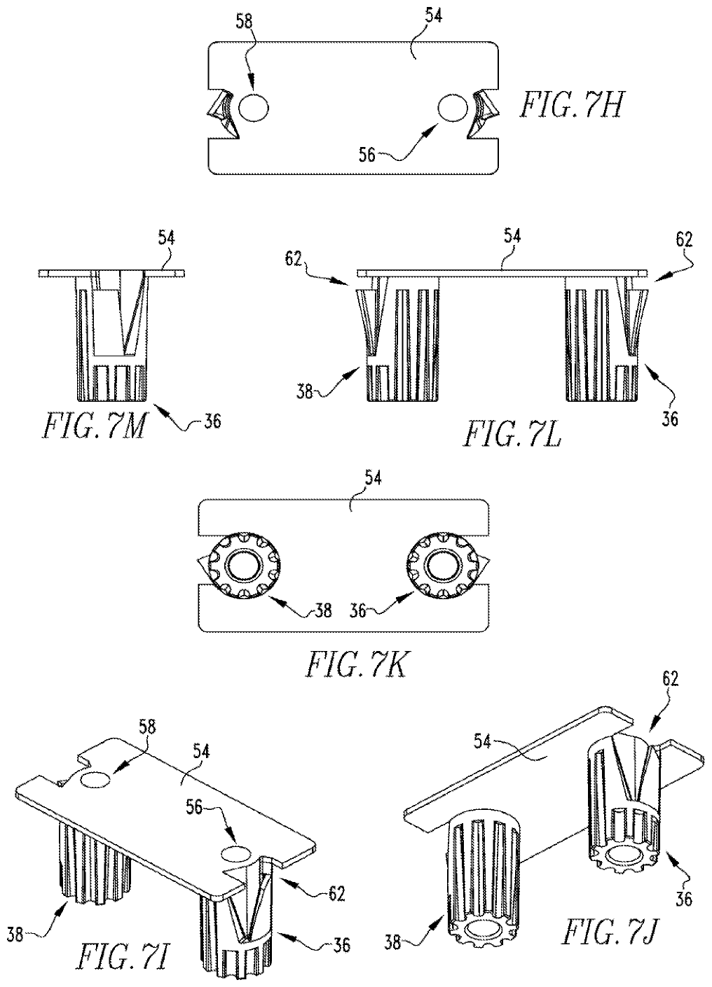

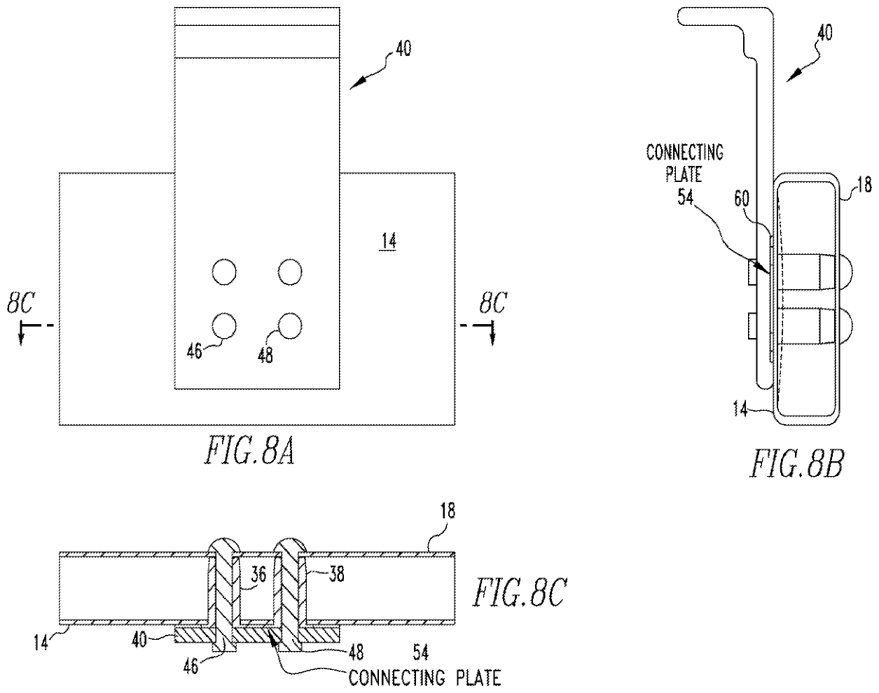

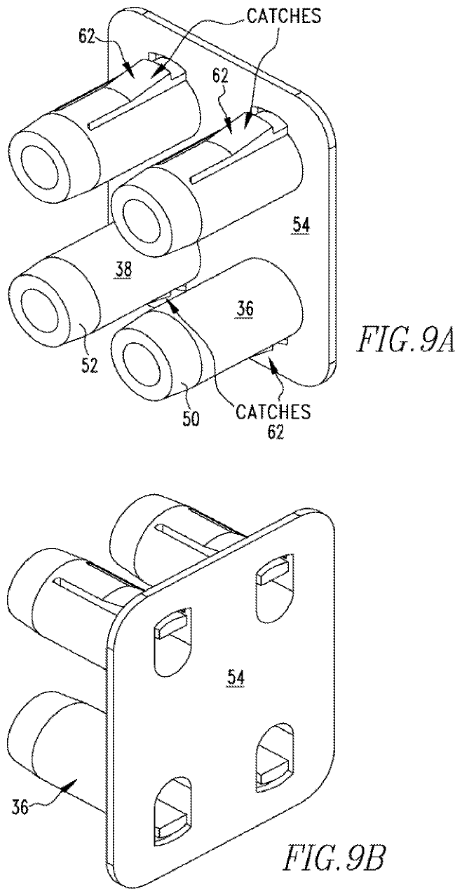

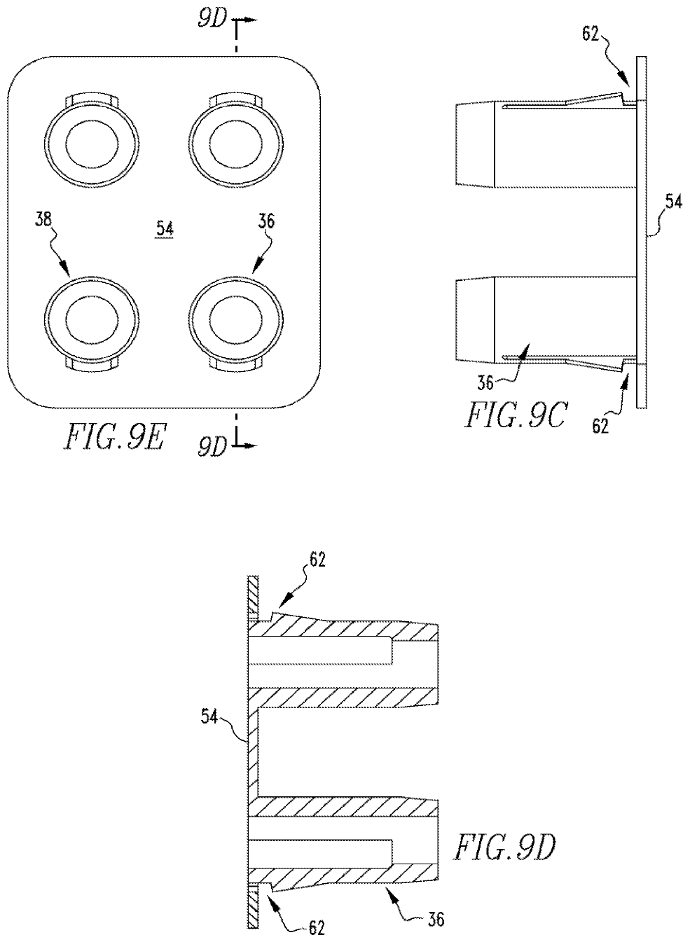

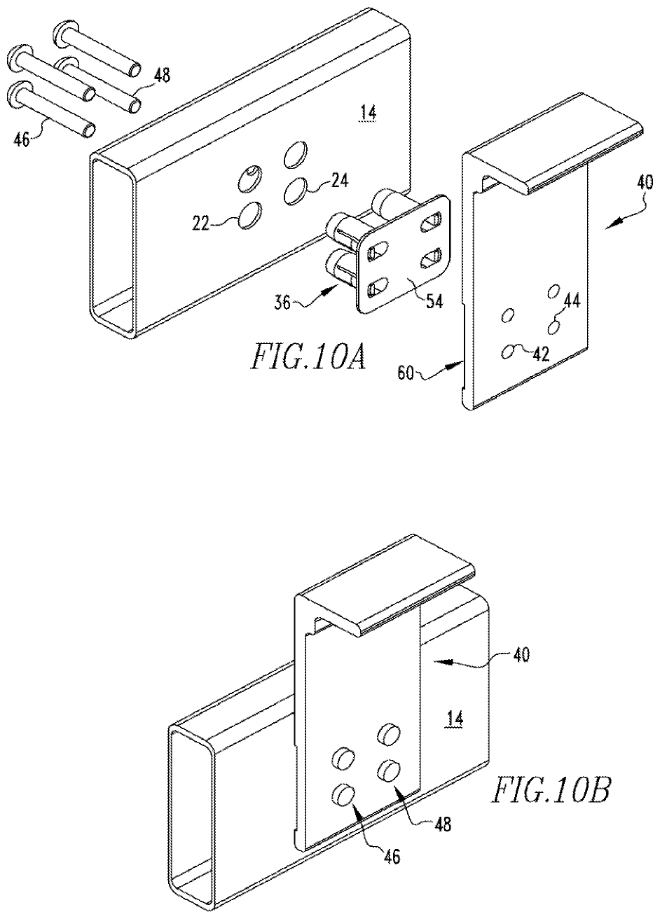

The ladder 10 may include a plate 54 having a first plate hole 56 and a second plate hole 58, as shown in FIGS. 7A-7M. The first and second tubes may be attached to the plate 54. The first tube 36 may be aligned with the first plate hole 56, and the second tube 38 may be aligned with the second plate hole 58.

The plate 54 may be disposed between the first side 14 and the bracket 40, as shown in FIGS. 8A-8C. The first fastener 46 may extend through the first hole 26 of the third side 18, the first tube 36, the first hole 22 of the first side 14, the first plate hole 56 and the first hole 42 of the bracket to fasten the bracket 40 to the first box rail 12. The second fastener 48 may extend through the second hole 28 of the third side 18, the second tube 38, the second hole 24 of the first side 14, the second plate hole 58 in the second hole 44 of the bracket to fasten the bracket 40 to the first box rail 12. The plate 54 and the first tube 36 and the second tube 38 may be one continuous piece. The bracket 40 may have a relief 60 in which the plate 54 fits. The first tube 36 and the second tube 38 each may have a catch 62 disposed adjacent the outside end 50 of the first tube 36 and the second tube 38 which retains the first and second tubes to the first side 14, as shown in FIGS. 9A-9K. FIGS. 9A-9E show a plate 54 having a total of four tubes extending from the plate 54. FIGS. 9A-9K show a plate 54 having a total of 2 tubes extending from the plate 54.

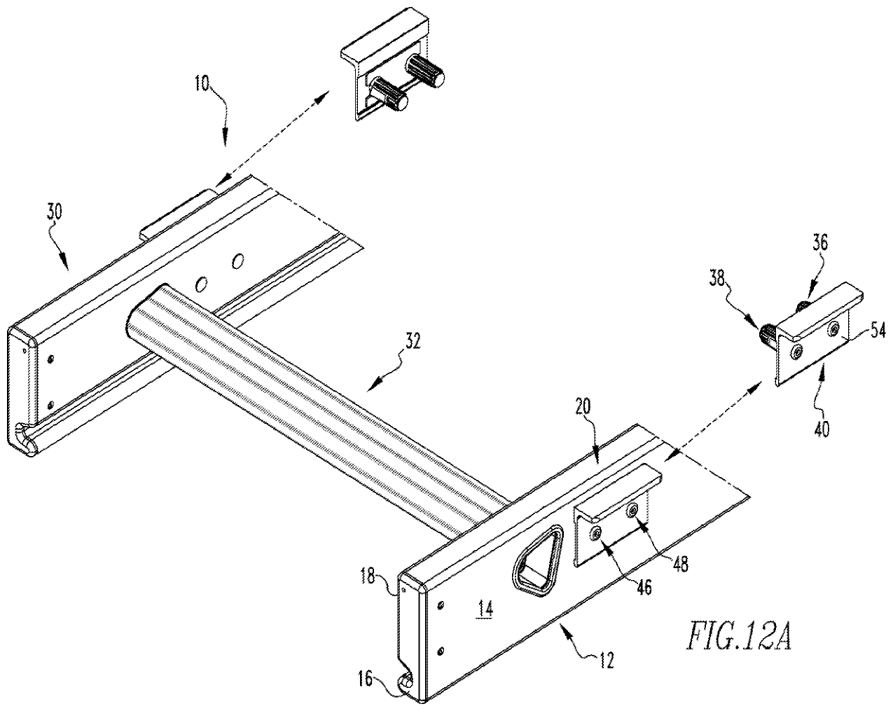

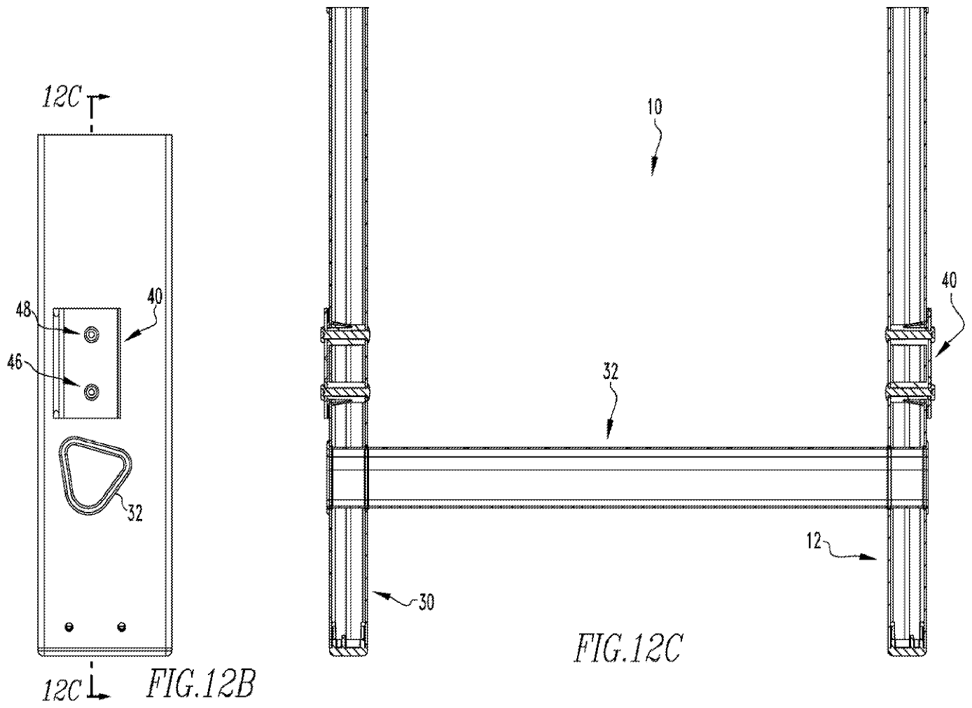

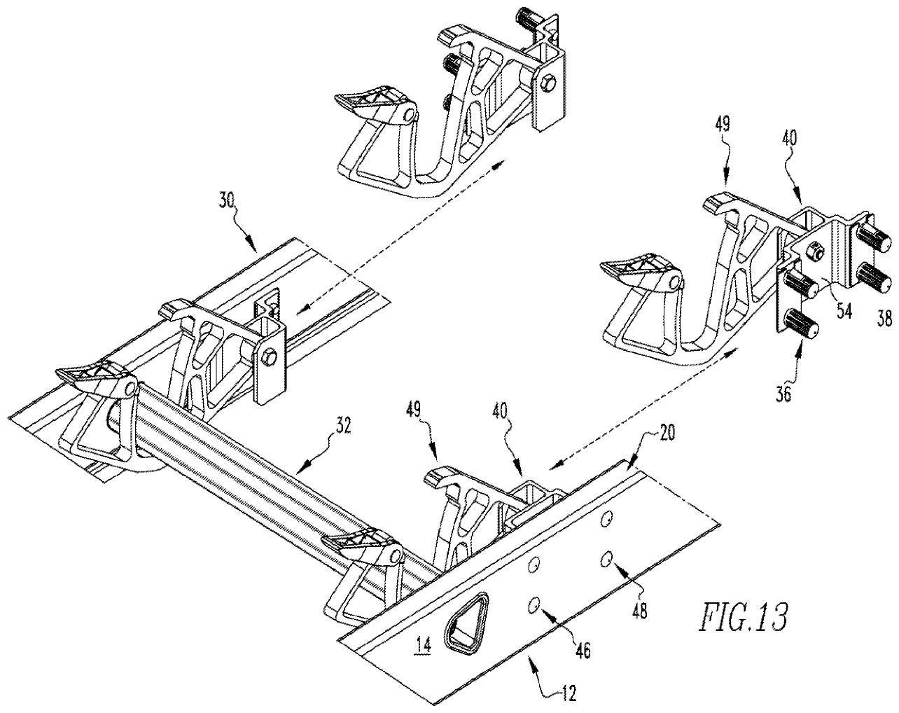

The first side 14 may be an external side relative to the second box rail 30 and the bracket 40 is disposed on the first side 14. The bracket 40 then may be a guide bracket, as shown in FIGS. 12A-12C. Alternatively, the first side 14 may be an external side relative to the second box rail 30 and the bracket 40 is disposed on the second side 16. The bracket 40 then may be a lock bracket, as shown in FIG. 13 to hold a lock 49.

The present invention pertains to a method for using a ladder 10. The method comprises the steps of moving the ladder 10 to a desired location. There is the step of securing the ladder at the desired location so a user may safely climb the ladder. The ladder 10 is described above.

The present invention pertains to a method for producing a ladder 10. The method comprises the steps of attaching a bracket 40 to a first box rail 12 of the ladder 10 by inserting a first fastener 46 through a first hole 26 of a third side 18 of the first box rail 12 of the ladder, a first hollow tube 36, a first hole 22 of a first side 14 of the first box rail 10 and a first hole 42 of the bracket 40. The ladder 10 having a second box rail 30, at least a portion of which is in parallel and spaced relation with the first box rail 12, a first rung 32 attached to and extending between the first and second box rails, and a second rung 34 attached to and extending between the first and second box rails. There preferably is the step of inserting a second fastener 48 extending through a second hole 28 of the third side 18, a second hollow tube 38, a second hole 24 of the first side 16 and a second bracket hole 44 of the bracket 40 so the first hollow tube 36 is disposed in the first box rail 12 in alignment with the first hole 22 of the first side 16 and the first hole 26 of the third side 18. The second hollow tube 38 is disposed in the first box rail 12 in alignment with the second hole 24 of the first side 14 and the second hole 28 of the second side 16, and the first bracket hole 42 of the bracket 40 is in alignment with the first hole 22 of the first side 14 and the second bracket hole 44 is in alignment with the second hole 24 of the first side 14.

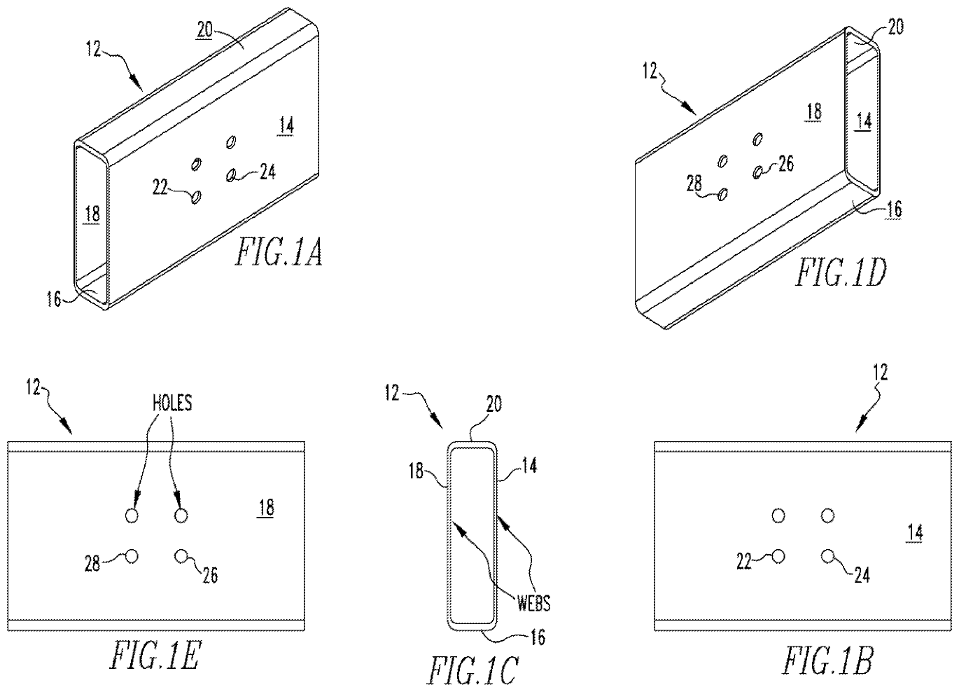

In the operation of the invention, FIGS. 1A-1E show a short section of a hollow structural member, in this case, a pultruded FG rail having a rectangular section. This is commonly called a box rail. The longer sides of the rectangular section, the first side 14 and third side 18, are the webs. It is to the webs that components of a ladder 10 are usually attached. There are holes in both webs of the box rail to permit the insertion of fasteners.

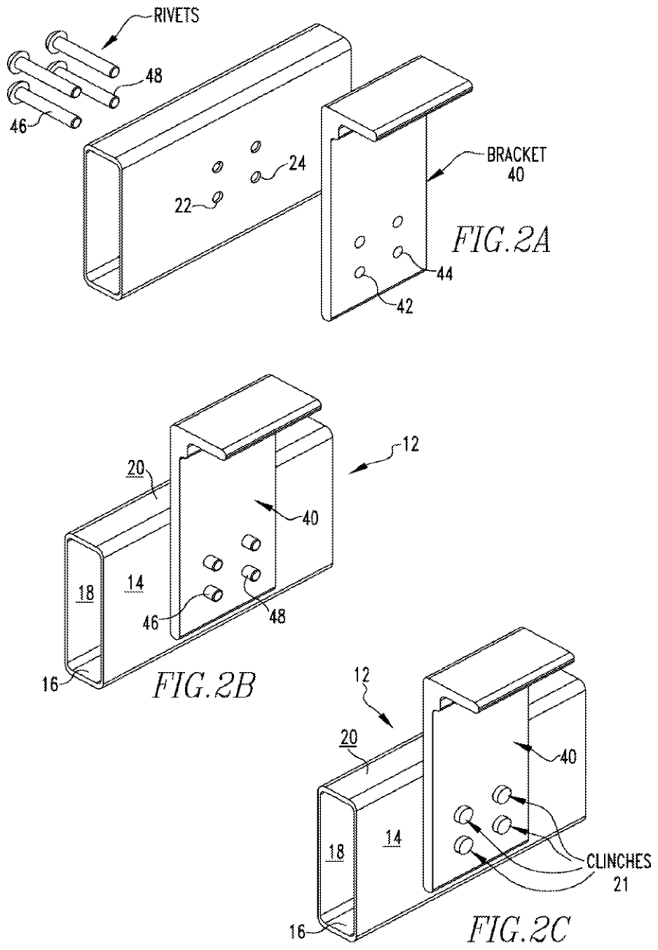

FIGS. 2A and 2B show the assembly of a guide bracket to the box rail using solid rivets but without any kind of backup.

FIG. 2C shows the rivets clinched with clinches 21.

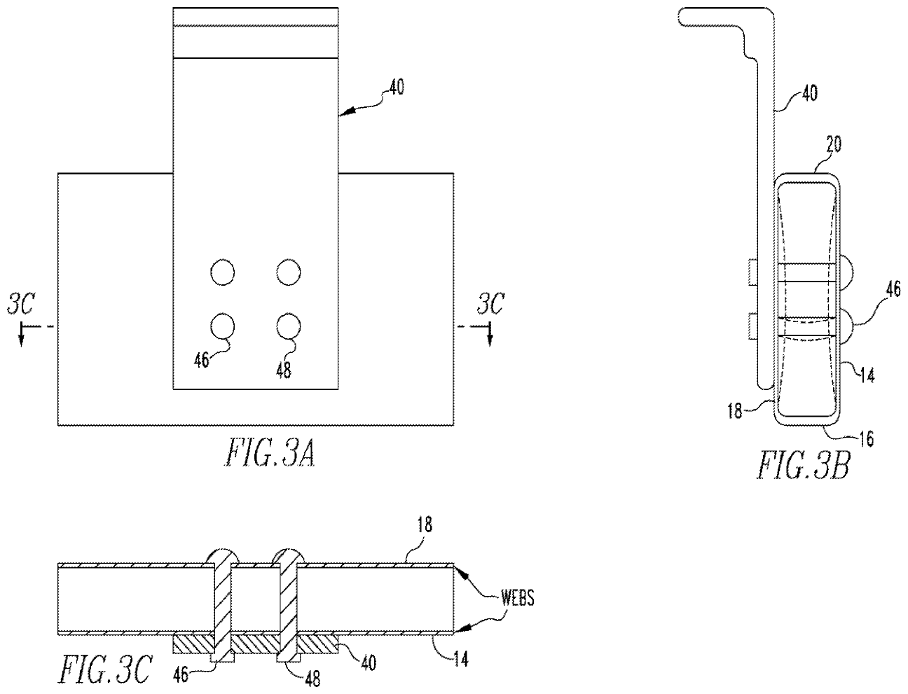

FIGS. 3A-3C provide views of the interaction of the unsupported rivets with the box rail.

The dashed lines in FIG. 3B show how the box rail webs are likely to bow inward and the shank of the rivets themselves are likely to bend under the force required to clinch the rivets.

In FIG. 3C, it can be seen that the axial tightness of the rivets can never be greater than the stiffness of the box rail webs. It is clear that some kind of backup support for the rivet shanks and the box rail webs is needed.

FIGS. 4A-4E show how a box rail would be pierced to receive the backup supports of this invention. The small holes are a close fit for the rivet shanks. The large holes permit insertion of the backup supports described below.

FIGS. 5A-5C show the simplest embodiment of this invention.

FIG. 5A is a plastic tube whose ID matches the rivet shank diameter and whose OD matches the large holes in the box rail. The tubes could be made of nylon, polypropylene, etc.

FIGS. 5B, 5C, and 5D show the tubes, rivets and bracket 40 being assembled and the rivets clinched.

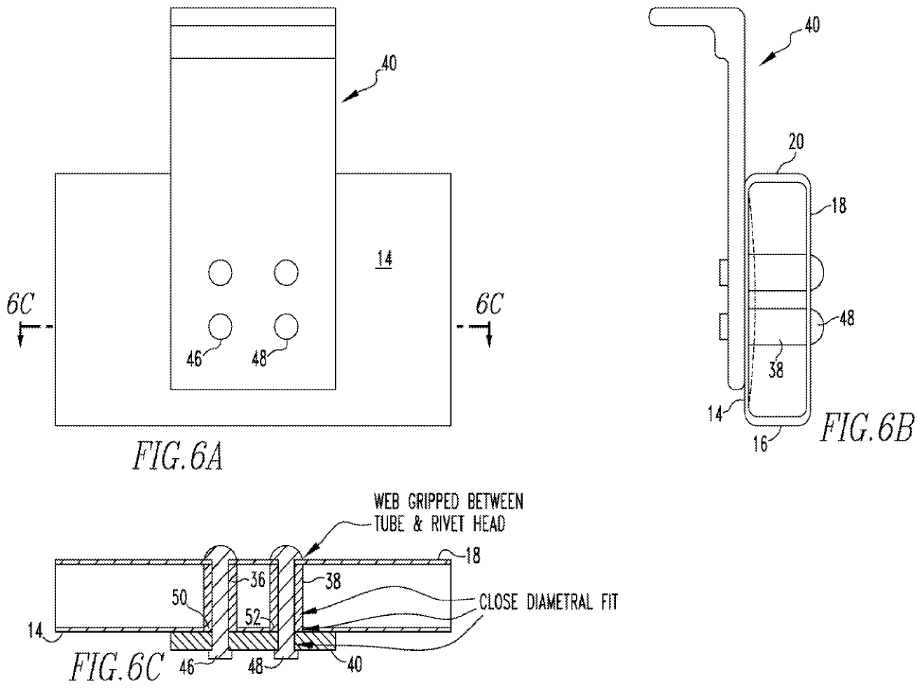

FIGS. 6A-6C show the interaction of the rivets, webs, backups and bracket 40.

The dashed line in FIG. 6B shows that the web adjacent to the bracket 40 is free to flex inward. However, it is not forced inward by the action of clinching the rivets.

The opposite web is supported by the backup tubes 36, 38.

The rivet shanks are prevented from bending due to their close fit in the plastic tubes IDs.

In FIG. 6C, it can be seen that one web of the box rail is tightly gripped between the rivet heads and one end of the backup support tubes. The clinched ends of the rivets tightly grip the bracket 40 against the opposite ends of the backup support tubes.

Thus, rigid attachment of the bracket 40 to the box rail is accomplished by the close diametral fit between the rivets, rivet holes in bracket 40, ID and OD of the backup tubes 36, 38, and large holes 22, 24 in the box rail web 14. Additionally, the bracket 40 is firmly held in the axial direction of the rivets due to the opposite box rail web 16 being gripped between the rivet heads and the backup tubes.

FIGS. 7A-7M show an improvement over FIGS. 5A-5D.

FIGS. 7A and 7E-7G shows four backup tubes molded together in a bundle with a thin plate 54 connecting them to each other.

FIG. 7C shows how all four backup support tubes may be inserted into the box rail simultaneously.

FIG. 7D shows the assembly with rivets clinched.

FIGS. 7H-7M shows two backup tubes having catches 62 molded together in a bundle with a thin plate 54 connecting them to each other.

Note, in FIG. 7B that the bracket 40 may be formed with a relief 60 corresponding to the size of the thin connecting plate. This relief 60 enables the bracket 40 to make contact with the web of the box rail as FIGS. 8B and 8C show.

FIGS. 8A-8C show that the bracket 40 is firmly clinched against the thin plate of the backup support tubes. The relief 60 in the bracket 40 permits the bracket 40 to also contact the adjacent web.

The web opposite the bracket 40 is firmly gripped between the rivet heads and the backup support tubes.

As in FIG. 6B, the web adjacent to the bracket 40 is free to flex inward but it is not forced inward by the action of clinching the rivets.

FIGS. 9A-9E show a further development of the embodiment of FIGS. 7A-7G. Catches 62 are formed on one side of each of the four backup support tubes within the bundle.

FIGS. 10A and 10B show the assembling and final clinched condition of the bracket 40 and box rail assembly. The catches 62 deflect inward as the backup tube bundle is inserted into the box rail. At full insertion, the catches 62 move outward again. This snap action of the catches 62 retain the backup tube bundle because the catches 62 grip the inside of the box rail web.

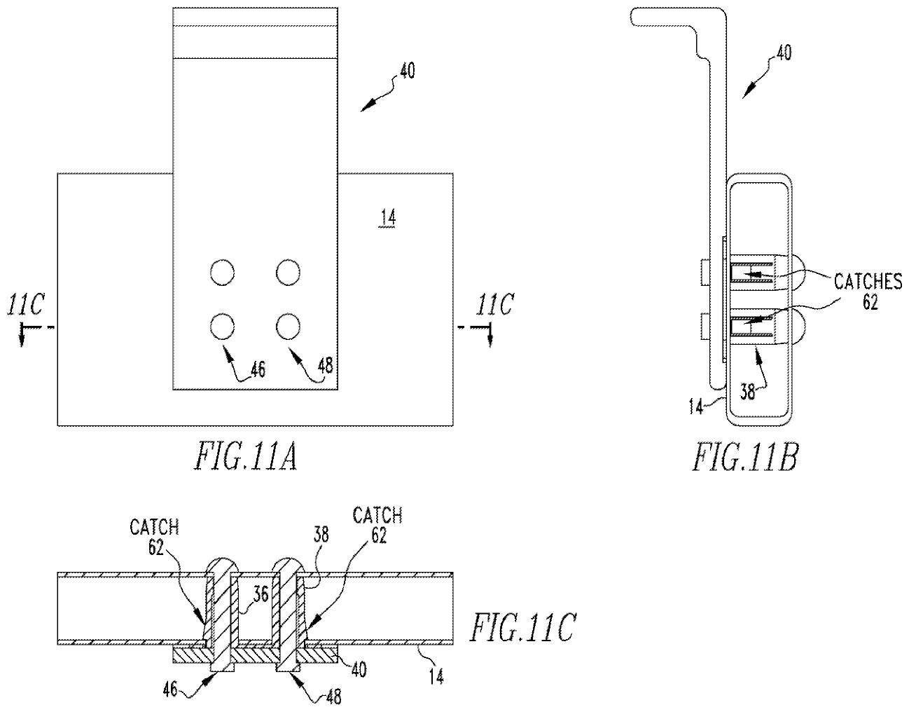

FIGS. 11A-11C show how the catches 62 on the backup tube bundle support the web adjacent to the bracket 40 so that it will not flex inward.

Bundles with two or four backup support tubes are shown but bundles with only one or any number of tubes could also be made depending on the hole patterns of the components being attached to the box rail. Solid rivets are shown, but semi-tubular rivets or threaded bolts and nuts could also be used as fasteners with this invention. The ladder 10 can support 250 lbs., 350 lbs. and even 500 lbs. pounds of compressive load without failing or cracking or bending, depending on the thickness of the materials used, such as metal—aluminum or steel—or fiberglass or other composites.

One way to join a hollow rung to a ladder box rail, the rung is inserted through close-fitting holes in the inner and outer webs of the box rail. The outboard end of the rung protrudes a short distance, about 0.200 inches, past the outer web of the box rail. Tooling is used to cause the outboard end of the hollow rung to be flared and rolled over. Additional tooling is used to internally expand or bulge the hollow rung within the region between the box rail webs until the rung fits tightly in the holes in the webs. Another way is described in concurrently filed U.S. patent application Ser. No. 16/795,171 filed with the U.S. Patent and Trademark Office on Feb. 19, 2020, incorporated by reference herein.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

1.-15. (canceled)

16. A ladder comprising:
a first box rail having a first side, a second side extending perpendicularly from the first side, a third side extending perpendicularly from the second side and in parallel and spaced relation with the first side, and a fourth side extending perpendicularly from the third side and in parallel and spaced relation with the second side, the first side having a rail hole, the third side having a rail hole in alignment with the rail hole of the first side;
a plate having a first plate hole bounded by an first edge that includes a first notch, the plate including a first tube coupled thereto, the first tube including a first wall disposed about the first plate hole, the first wall including a first catch that is aligned with the first notch, the first catch being generally rectangular in shape and having a first end fixed to and flush with the first wall and a second end a second end that is unattached to the first wall, at least a portion of the first tube disposed between the first side and the third side of the first box rail and in alignment with the rail hole of the first side and the rail hole of the third side; and
a bracket having a first bracket hole in alignment with the rail hole of the first side and the first plate hole.

17. The ladder of claim 16, wherein the second end of the first catch has a thickness greater than a thickness of the first end such that the second end protrudes beyond the first wall of the first tube, and wherein the second end of the first catch is disposed within the first notch.

18. The ladder of claim 16, further comprising:
a first fastener extending through the rail hole of the third side, the first tube, the rail hole of the first side, and the first bracket hole which attaches the bracket to the first box rail.

19. The ladder of claim 16, wherein the bracket is an L-shaped bracket having a first portion coupled to the first side of the first box rail and a second portion that extends perpendicular from the first portion.

20. The ladder of claim 16, wherein the ladder further comprises:
a second box rail parallel to and spaced from the first box rail; and
a plurality of rungs disposed between the first box rail and the second box rail.

21. The ladder of claim 20, wherein the ladder is an extension ladder and the first box rail and second box rail are part of a fly section of the extension ladder.

22. The ladder of claim 21, wherein the bracket is at least one of a guide bracket that engages a box rail of a fly section of the extension ladder or a lock bracket coupled to a lock that engages one of the plurality of rungs.

23. The ladder of claim 16, wherein the bracket is disposed on the third side of the first box rail.

24. The ladder of claim 16, wherein the plate further includes a second plate hole bounded by an edge that includes a second notch, the plate including a second tube coupled thereto, the second tube including a second wall disposed about the second plate hole, the second wall including a second catch that is aligned with the second notch, the second catch being generally rectangular in shape and having a first end fixed to and flush with the second wall and a second end a second end that is unattached to the second wall.

25. The ladder of claim 24, wherein at least a portion of the second tube disposed between the first side and the third side of the first box rail and in alignment with the rail hole of the first side and the rail hole of the third side.

26. The ladder of claim 24, wherein the plate has a first edge, a second edge that extends perpendicular from the first edge, and a third edge opposite the first edge, wherein the first notch is disposed adjacent the first edge and the second notch is disposed adjacent to the third edge.

27. The ladder of claim 24, wherein the first catch is disposed opposite the second catch.

28. The ladder of claim 16, wherein the rail hole on the first side has a larger diameter than the rail hole on the second side.

29. A ladder having a component coupled thereto, the ladder comprising:
a first box rail having a first side, a second side extending perpendicularly from the first side, a third side extending perpendicularly from the second side and in parallel and spaced relation with the first side, and a fourth side extending perpendicularly from the third side and in parallel and spaced relation with the second side, the first side having a rail hole, the third side having a rail hole in alignment with the rail hole of the first side;
a plate having a first plate hole bounded by an first edge that includes a first notch, the plate including a first tube coupled thereto, the first tube including a first wall disposed about the first plate hole, the first wall including a first catch that is aligned with the first notch, the first catch being generally rectangular in shape and having a first end fixed to and flush with the first wall and a second end a second end that is unattached to the first wall, at least a portion of the first tube disposed between the first side and the third side of the first box rail and in alignment with the rail hole of the first side and the rail hole of the third side; and
a first fastener disposed within the first tube and through a hole in the component to couple the component to the first box rail.

30. The ladder of claim 29, wherein the ladder further comprises:
a second box rail parallel to and spaced from the first box rail; and
a plurality of rungs disposed between the first box rail and the second box rail.

31. The ladder of claim 29, wherein the second end of the first catch is disposed within the first notch.

32. The ladder of claim 29, wherein the plate and the first tube are a continuous piece.

33. A mounting system for a box rail, the mounting system comprising:
a plate having a first plate hole bounded by an first edge that includes a first notch, the plate including a first tube coupled thereto, the first tube including a wall disposed about the first plate hole, the wall including a first catch that is aligned with the first notch, the first catch being generally rectangular in shape and having a first end fixed to and flush with the wall and a second end a second end that is unattached to the wall;
a bracket including a bracket body having a bracket hole and a second end including a leg portion cantilevered from the bracket body; and
a fastener that is sized to be received by the first tube, the first plate hole, and the bracket hole.

34. The mounting system of claim 33, wherein the plate further includes a second plate hole bounded by an edge that includes a second notch, the plate including a second tube coupled thereto, the second tube including a second wall disposed about the second plate hole, the second wall including a second catch that is aligned with the second notch, the second catch being generally rectangular in shape and having a first end fixed to and flush with the second wall and a second end a second end that is unattached to the second wall.

35. The mounting system of claim 34, wherein the second end of the first catch is disposed within the first notch and the second end of the second catch is disposed within the second notch.
